(19) United States
(12) Patent Application Publication
(10) Pub. No.: US 2023/0099488 A1
(43) Pub. Date: Mar. 30, 2023

(54) ELECTRIC MOTOR FOR A POWER TOOL

(71) Applicant: MILWAUKEE ELECTRIC TOOL CORPORATION, Brookfield, WI (US)

(72) Inventor: Shu Bin HU, Dongguan City (CN)

(21) Appl. No.: 17/052,469

(22) PCT Filed: Jun. 1, 2020
(86) PCT No.: PCT/US2020/035530

§ 371 Date: Nov. 2, 2020

(30) Foreign Application Priority Data
Jun. 3, 2019 (CN) 201920830182.3

(51) Int. Cl. H02K 9/06; H02K 7/04; H02K 7/14

(52) U.S. Cl. CPC H02K 9/06; H02K 7/04; H02K 7/145

(57) ABSTRACT

An electric motor includes a balancing member coupled to an output shaft for rotation with a rotor. The balancing member substantially balances a mass of the rotor about a longitudinal axis. The balancing member includes a bushing supported on the output shaft and is positioned between a face of the rotor and a fan. The bushing includes a balancing feature formed on an outer circumference of the bushing.

### FIELD OF THE INVENTION

The present invention relates to power tools and, in particular, to electric motors for use with power tools.

### BACKGROUND OF THE INVENTION

Many power tools use an electric motor, such as brushless DC motor, to drive the tool. A brushless DC motor typically includes a rotor and a stator. During operation, the rotor rotates at a relatively high-speed relative to the stator. If the motor is unbalanced, the power tool may vibrate or shake during use. Current balancing features include a plurality of bushings disposed on a shaft, for which the rotor rotates thereon.

### SUMMARY OF THE INVENTION

In one embodiment, the invention provides an electric motor for use with a power tool. The electric motor includes a stator, a rotor rotatable relative to the stator, an output shaft coupled to the rotor for rotation with the rotor, a fan coupled to the output shaft for rotation with the output shaft and the rotor, and a balancing member coupled to the output shaft for rotation with the rotor. The output shaft defines a longitudinal axis about which the rotor rotates. The balancing member substantially balances a mass of the rotor about the longitudinal axis. The balancing member includes a bushing supported on the output shaft and is positioned between a face of the rotor and the fan. The bushing includes a balancing feature formed on an outer circumference of the bushing.

In another embodiment, the invention provides a power tool. The power tool includes a housing, a drive mechanism positioned within the housing, and an electric motor positioned within the housing and operable to drive the drive mechanism. The electric motor includes a stator, a rotor rotatable relative to the stator, an output shaft coupled to the rotor for rotation with the rotor, a fan coupled to the output shaft for rotation with the output shaft and the rotor, and a balancing member coupled to the output shaft for rotation with the rotor. The output shaft defines a longitudinal axis about which the rotor rotates. The balancing member substantially balances a mass of the rotor about the longitudinal axis. The balancing member includes a bushing supported on the output shaft and is positioned between a face of the rotor and the fan. The bushing includes a balancing feature formed on an outer circumference of the bushing.

Other aspects of the invention will become apparent by consideration of the detailed description and accompanying drawings.

### BRIEF DESCRIPTION OF THE DRAWINGS

FIG. 1 is a side view of a power tool.

FIG. 2 is a perspective view of a motor of the power tool shown in FIG. 1.

FIG. 3 is a perspective view of the motor of FIG. 2 with portions of the motor removed.

FIG. 4 is a perspective view of the motor of FIG. 3 with a balancing feature formed on a bushing.

FIG. 5 is a first side view of the motor of FIG. 3.

FIG. 6 is a second side view of the motor of FIG. 3.

FIG. 7 is a second perspective view of the motor of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION OF THE INVENTION

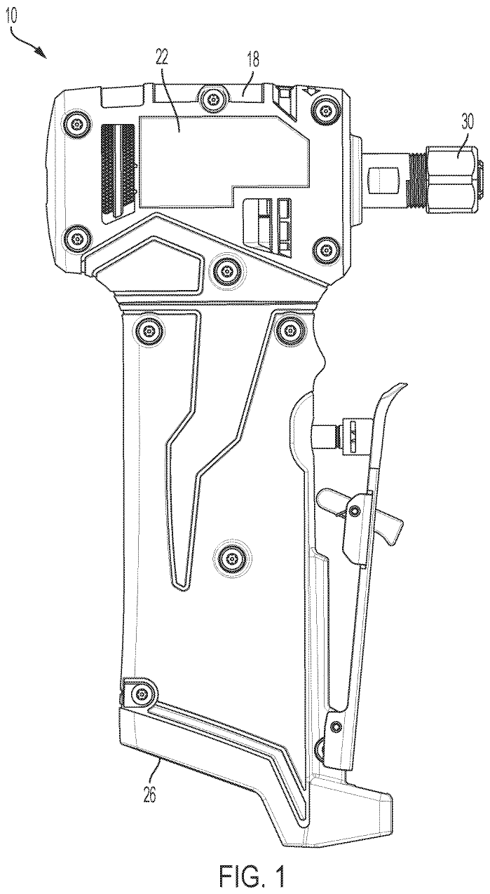

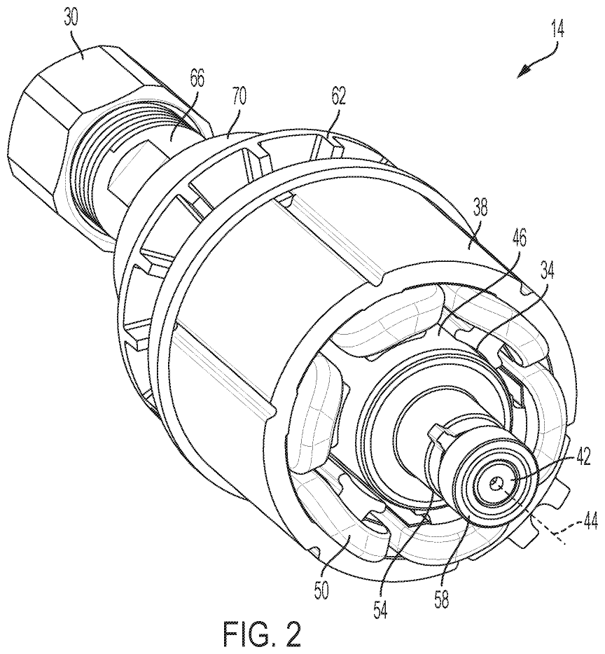

FIG. 1 illustrates a power tool 10 including an electric motor 14 (FIG. 2), such as a brushless DC motor. In the illustrated embodiment, the power tool 10 is a multi-tool. In other embodiments, the power tool may be, for example, a reciprocating saw, a circular saw, a jigsaw, a drill, an impact driver, a screwdriver, a pipe cutter, a grinder, a sander, a caulk gun, a grease gun, or the like. In further embodiments, the power tool 10 may be another type of device that uses an electric motor, such as a vacuum, a paint sprayer, lawn and garden equipment, or the like.

The motor 14 is positioned in a housing 18 of the power tool 10 and connected to a drive mechanism 22. The illustrated power tool 10 also includes a battery connection portion 26 formed on the housing 18. The battery connection portion 26 receives a battery pack (not shown) to electrically couple the battery pack to the motor 14 through a switch and other electronics. The battery pack may be, for example, a 9V, 12V, 18V, 28V, or 36V Li-ion or NIMH battery pack. When powered, the electric motor 14 drives the drive mechanism 22 to operate a working element 30 (e.g., a drill bit) connected to a chuck of the power tool.

FIG. 2 illustrates the electric motor 14 in more detail. The motor 14 includes a rotor 34, a stator 38, and a motor shaft 42. The rotor 34 includes permanent magnets (not shown) positioned in a body 46, or stack, of the rotor 34. The body 46 may be a laminated steel structure or powdered steel. The magnets are received in corresponding slots (not shown) formed in the body 46 and extend between a first face 46A and a second face 46B of the body 46. The illustrated stator 38 includes six electromagnetic coils 50 surrounding the rotor 34. The coils 50 are surrounded by laminations of the stator 38. When powered, the electromagnetic coils 50 create magnetic fields that interact with the permanent magnets in the rotor 34 to rotate the rotor 34 relative the stator 38. In other embodiments, the motor 14 may include any number of permanent magnets in the rotor and/or electromagnetic coils in the stator 38. Although in the illustrated embodiment the magnets are positioned within the rotor body 46 such that the magnets are interior permanent magnets, in other embodiments the magnets may be glued or otherwise affixed onto an outer surface of the rotor body 46 such that the magnets are surface permanent magnets.

The motor shaft 42, or output shaft, extends out of the rotor 34 to rotate with the rotor 34. The shaft 42 defines a longitudinal axis 44 about which the rotor 34 rotates. The shaft 42 is fixed to the rotor 34 such that movement of the rotor 34 is transmitted to the shaft 42. In some embodiments, the shaft 42 may be fixed to the rotor 34 using suitable securing means, such as splines, knurls, press-fitting, adhesives, or the like. In other embodiments, a portion of the shaft 42 may be non-cylindrical to rotationally fix the shaft 42 to the rotor 34, such that the shaft 42 rotates with the rotor 34.

A first bearing 54 is positioned on a first end 58 of the shaft 42 to support the shaft 42, and thereby the motor 14, within the housing 18 of the power tool 10. A fan or impeller 62 is coupled to a second end 66 of the shaft 42 to rotate with the shaft 42 and the rotor 34. The fan 62 creates an airflow around the motor 14 to cool the motor 14 during operation of the power tool 10. A second bearing 70 (FIG. 7) is coupled to the second end 66 of the shaft 42 adjacent the fan 62 to help support the motor 14 in the housing 18 of the power tool 10.

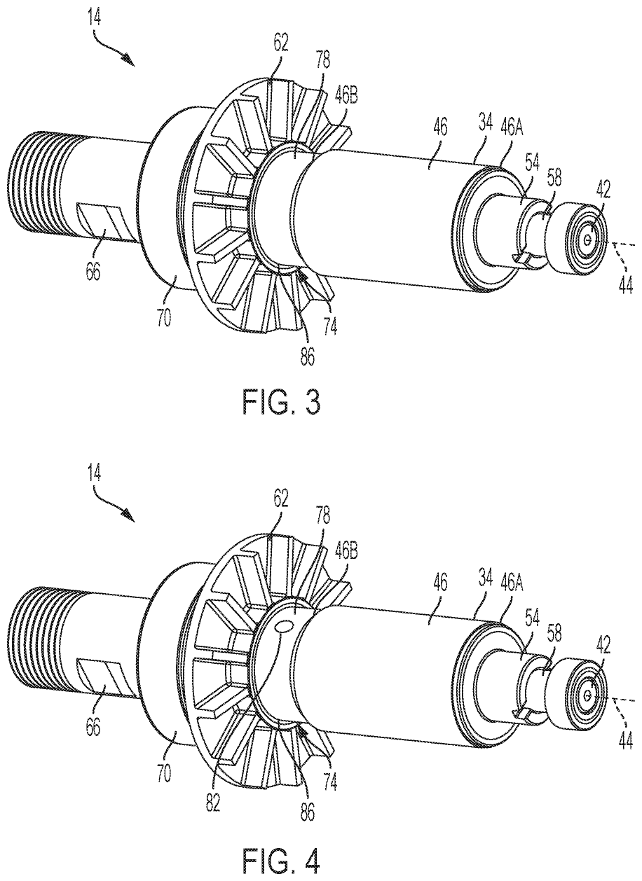

FIG. 3 illustrates the motor 14 with the stator 38 removed. The motor 14 further includes a balancing member 74 comprising a bushing 78. The illustrated bushing 78 is generally cylindrical with a hole extending through the center of the bushing such that the bushing is received onto the shaft 42. The bushing 78 is composed of a non-magnetic, high density material such as brass. In some embodiments, the bushing 78 may be composed of an alternative non-magnetic material, such as aluminum, copper, lead, or the like.

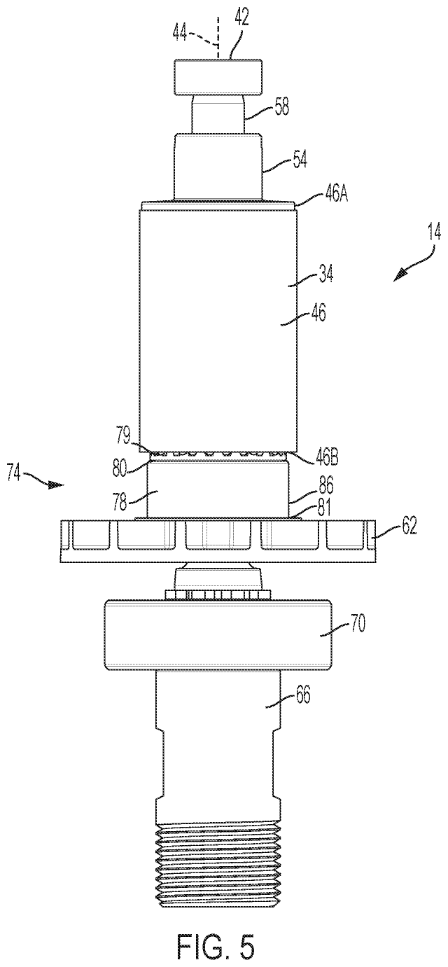

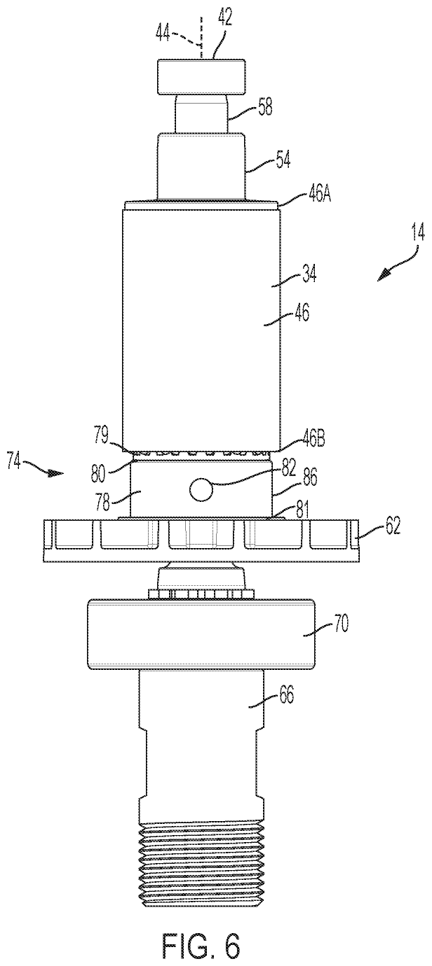

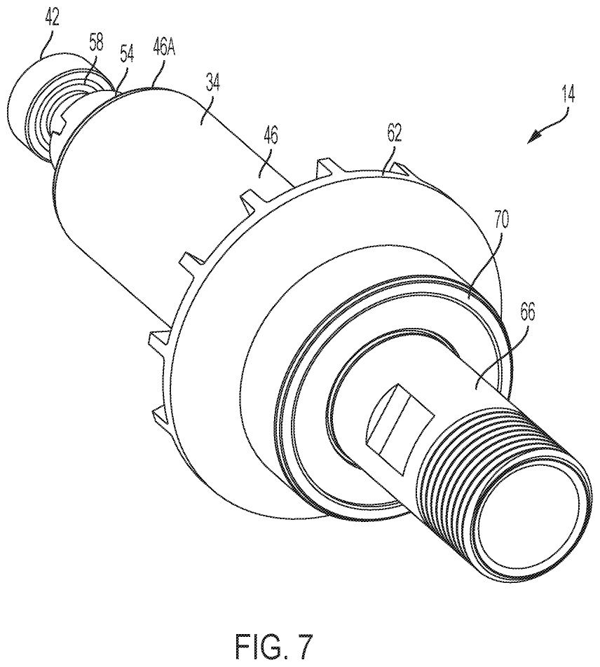

With reference to FIGS. 5 and 6, the bushing 78 is positioned between the rotor body 46 and the fan 62, such that the bushing 78 is coupled to the second face 46B of the rotor body 46 via a spline 79 feature formed on a first side 80 of the bushing 78, and the bushing is integrally formed with a portion of the fan 62 on a second side 81 of the bushing 78. The second face 46B of the rotor body 46 is defined as a rotor lamination stack or endcap, meaning that the bushing 78 is in contact with the rotor lamination stack or endcap, as well as the portion of the fan 62. In some embodiments, the bushing 78 may be coupled to the rotor body 46 through alternative securing means such as knurls, press-fitting, or the like. In additional embodiments, the bushing 78 may not be directly secured to the rotor body 46.

In the illustrated embodiment, the second side 81 of the bushing 78, is integrally molded to the fan 62 for rotation therewith. In additional embodiments, the bushing 78 may be distinct from the fan 62 and coupled to the fan 62 through alternative securing means. The bushing 78 may also be fixed to the shaft 42 to rotate with the rotor 34 and the shaft 42 relative to the stator 38. In some embodiments, the bushing 78 may be secured to the shaft 42 and/or the fan 62 by splines, knurls, press-fitting, or the like. In additional embodiments, the bushing 78 may be solely secured to either the fan 62 or the shaft 42.

When the bushing 78 is assembled on the shaft 42, the bushing 78 rotates with the rotor 34 to help balance the motor 14. If the motor 14 is still imbalanced, a balancing feature 82 (FIG. 4) is formed on the bushing 78 to correct the imbalance within a predetermined specification. As shown in FIG. 4-7, the illustrated balancing feature 82 is machined in the bushing 78 by drilling a hole into an outer circumferential surface 86 of the bushing 78, such that some amount of material is removed from the outer circumferential surface 86 of the bushing 78. The balancing feature 82 may extend from the outer circumferential surface 86 of the bushing to the hole formed in the center of the bushing 78, or the balancing feature 82 may solely form a recession in the outer circumferential surface 86 of the bushing 78. The balancing feature 82 is angled such that an axis formed through the center of the balancing feature 82 intersects with the longitudinal axis 44, defined by the shaft 42. In other embodiments, other balancing features may be formed on the bushing by cutting, shaving, or otherwise removing material from the bushing. Additionally or alternatively, multiple balancing features may be formed on the bushing 78 to balance the motor within the predetermined specification. The additional balancing features may be formed on the outer circumferential surface 86 of the bushing 78, or an axial surface of the bushing 78.

In the illustrated embodiment, the motor 14 includes a singular bushing 78, which abuts the fan 62 and the second face 46B of the rotor 46. Since the balancing feature 82 is formed on the bushing 78 disposed between the rotor 46 and the fan 62, the need for additional bushings is eliminated, reducing the minimum length of required for the motor 14. Reducing the length of the motor 14 may, in turn, reduce the associated cost to manufacture the motor 14.

The balancing member 74 discussed above helps balance an electric motor 14 in a power tool 10, or other device, within a predetermined specification to reduce vibration of the motor 14 during use. In particular, the balancing member 74 balances masses of the corresponding rotor 34 about the longitudinal axis 44 of the motor 14 to reduce vibrations of the motor 14 compared to motors without balancing members. Additional balancing members may be combined with the balancing member 74 described above on a single motor to achieve the desired balance.

Although the invention has been described with reference to certain preferred embodiments, variations and modifications exist within the scope and spirit of one or more independent aspects of the invention as described.

What is claimed is:

1. An electric motor for use with a power tool, the electric motor comprising:
a stator;
a rotor rotatable relative to the stator;
an output shaft coupled to the rotor for rotation with the rotor, the output shaft defining a longitudinal axis about which the rotor rotates;
a fan coupled to the output shaft for rotation with the output shaft; and
a balancing member coupled to the output shaft for rotation with the rotor, the balancing member substantially balancing a mass of the rotor about the longitudinal axis;
wherein the balancing member includes a bushing supported on the output shaft and positioned between a face of the rotor and the fan, the bushing including a balancing feature formed on an outer circumference of the bushing.

2. The electric motor of claim 1, wherein the balancing feature is defined as a hole drilled into the outer circumference of the bushing.

3. The electric motor of claim 2, wherein the balancing feature extends through a thickness of the bushing.

4. The electric motor of claim 2, wherein the hole is angled such that a center axis of the hole intersects the longitudinal axis.

5. The electric motor of claim 1, wherein a plurality of balancing features are formed onto the bushing.

6. The electric motor of claim 1, wherein the face of the rotor defines a rotor lamination stack, and wherein the balancing member is in contact with the rotor lamination stack.

7. The electric motor of claim 1, wherein the bushing surrounds a portion of the output shaft adjacent the second face of the rotor.

8. The electric motor of claim 1, wherein the bushing is composed of a brass material.

9. The electric motor of claim 1, wherein the bushing is molded to the fan for rotation therewith.

10. The electric motor of claim 1, wherein the balancing member includes exactly one bushing.

11. A power tool comprising:
a housing;
a drive mechanism positioned within the housing; and
an electric motor positioned within the housing and operable to drive the drive mechanism, the motor including
a stator;
a rotor rotatable relative to the stator;
an output shaft coupled to the rotor for rotation with the rotor, the output shaft defining a longitudinal axis about which the rotor rotates;
a fan coupled to the output shaft for rotation with the output shaft; and
a balancing member coupled to the output shaft for rotation with the rotor, the balancing member substantially balancing a mass of the rotor about the longitudinal axis;
wherein the balancing member includes a bushing supported on the output shaft and positioned between a face of the rotor and the fan, the bushing including a balancing feature formed on an outer circumference of the bushing.

12. The power tool of claim 11, wherein the balancing feature is defined as a hole drilled into the outer circumference of the bushing.

13. The power tool of claim 12, wherein the balancing feature extends through a thickness of the bushing.

14. The power tool of claim 11, wherein a plurality of balancing features are formed onto the bushing.

15. The power tool of claim 11, wherein the balancing feature is formed on the bushing after the bushing is assembled on the output shaft.

16. The power tool of claim 11, wherein the bushing surrounds a portion of the output shaft adjacent the second face of the rotor.

17. The power tool of claim 11, wherein the bushing is composed of a brass material.

18. The power tool of claim 11, wherein the bushing is molded to the fan for rotation therewith.

19. The power tool of claim 11, wherein the balancing member includes exactly one bushing.
